(19) United States
(12) Patent Application Publication
(10) Pub. No.: US 2008/0236062 A1
(43) Pub. Date: Oct. 2, 2008

(54) Ventilation Sleeve for Concrete Foundation Walls

(76) Inventor: John Bergaglio, Kings Park, NY (US)

Correspondence Address: MICHAEL I KROLL, 171 STILLWELL LANE, SYOSSET, NY, 11791, US

(21) Appl. No.: 11/691,961

(22) Filed: Mar. 27, 2007

(51) Int. Cl. E02D 19/00; E06B 9/01

(52) U.S. Cl. 52/169.5; 49/57

(57) ABSTRACT

A vent for a building structure, specifically for the foundation thereof, having a bi-directional breakaway swing door that releases in either direction once a predetermined PSI of pressure is applied thereto. This is done to meet building codes in flood prone areas and to protect the structure in the event of flooding as the breakaway door opens accordingly once 10-20 PSI is exerted thereupon.

### BACKGROUND OF THE INVENTION

1. Field of the Invention

The present invention relates generally to ventilation of static structures and, more specifically, to a vent that may be installed in a poured concrete wall, or existing wall, while having a bi-directional break-away swing door to allow for the ingress and egress of flood water therethrough. The top edge of the bi-directional door is pivotally attached to a housing and the bottom edge has a flexible gasket extending the length thereof. The flexible gasket resides within a retaining channel in the bottom portion of the housing under normal conditions but the resiliency of the gasket releases it therefrom when exposed to 10-20 PSI of pressure due to buildup of water or other such elements.

The door comprises a metallic frame having a screen secured thereto and a magnetic winter plate that is placed thereon to prevent airflow therethrough in cold weather without the need of hardware or tools.

The need for the present invention has arisen because building codes are changing for flood prone areas and in line with the breakaway wall, where the homeowner is sacrificing the first floor for continued structural integrity of the upper floors, this device is used for homes having crawl spaces so that air is free to move in and out reducing mold and mildew. Furthermore, when the water rises 10 to 20 pounds of pressure will allow the water to flow into the crawl space and when the water recedes it will flow out of the crawl space. In other words, the water pressure increases as the flood water rises which can fracture or crush the foundation with the potential of the house floating away. This will not prevent water damage but may save the house after the water recedes.

2. Description of the Prior Art

There are other vent devices designed for the same purpose. Typical of these is U.S. Pat. No. 4,000,623 issued to Meardi on Jan. 4, 1977.

Another patent was issued to Ikeda et al on Jan. 2, 1979 as U.S. Pat. No. 4,132,498. Yet another U.S. Pat. No. 4,178,110 was issued to Cobbs on Dec. 11, 1979 and still yet another was issued on Feb. 12, 1985 to Koniger, et al as U.S. Pat. No. 4,498,271.

Another patent was issued to Hall et al on Jul. 2, 1985 as U.S. Pat. No. 4,526,493. Yet another U.S. Pat. No. 4,887,789 was issued to Harris et al on Dec. 19, 1989. Another was issued to Triandafilou on Dec. 22, 1998 as U.S. Pat. No. 5,851,564 and still yet another was issued on Mar. 16, 1999 to Ole as U.S. Pat. No. 5,881,510.

Another patent was issued to Anderson et al on Dec. 7, 1999 as U.S. Pat. No. 5,996,293. Yet another U.S. Pat. No. 6,070,375 was issued to Anderson et al on Jun. 6, 2000. Another was issued to Myers, et al. on Feb. 13, 2001 as U.S. Pat. No. 6,185,884. Another was issued on Mar. 20, 2001 to Partee et al U.S. Pat. No. 6,202,369. Another was issued to McKinney, et al. on Oct. 16, 2001 as U.S. Pat. No. 6,302,785 and still yet another was issued on Sep. 24, 2002 to Williams, et al. as U.S. Pat. No. 6,453,620.

Another patent was issued to Ikeda et al. on Apr. 22, 2003 as U.S. Pat. No. 6,550,819. A patent application was filed by Beltran on May 30, 2002 and published as publication number US2002/62620 another patent U.K. Patent No. GB2,307,530 was issued to Gibbons on May 28, 1997.

### U.S. Pat. No. 4,000,623

### Inventor: Pietro Meardi

### Issued: Jan. 4, 1977

An anchor rod for supporting walls, bulkheads and the like, comprises: an anchoring body to be cemented to the ground, at the bottom of a hole for the rod, by burying it into a casting of cement mixture, forming therewith the anchor bulb of the rod; traction cables connecting said anchoring body to a head-piece being fixed to the wall or like to be supported; two pipes containing and protecting said cables inside said hole, the first of said pipes carrying centering members, distributed throughout its length, and an inflatable plugging sleeve close to its end opposite to the head-piece, while the second pipe is telescoped into the first one, in correspondence of the end; and one pipe for feeding said cement mixture to form said bulb. The anchoring body consists of a frustoconical element, connected with its minor base to the end of said second pipe and housing, at its major outer base, a connection plate for the traction cables, being crossed by the pipe for feeding the cement mixture.

### U.S. Pat. No. 4,132,498

### Inventor: Isamu Ikeda

### Issued: Jan. 2, 1979

An anchor removing device is constituted by providing a wedge shaped breaking means tapered in the drawing-out direction, which is temporarily secured to the tip portion of an anchor steel member and a tension steel member encompassed with sheath coupled to the wedge shaped breaking means. After this anchor removing device has been inserted into anchor hole which is bored in the ground, a hardenable filler material is injected into the anchor hole to form an anchor body. The hardenable filler material may produce voids or contains a foreign material of a low rigidity, which produces the effect similar to that of voids, such as air bubbles. The material may be foamable polystyrene and a cork of a given porosity. Typical example of the hardenable filler material is a foamed concrete milk. At the time of removing the anchor, the edge shaped breaking means is withdrawn by pulling the tension steel member with a jack or the like. Simultaneously with the withdrawal of the wedge shaped breaking means, the breaking means will break the anchor body covering same, thereby detaching the anchor body from the anchor steel member.

### U.S. Pat. No. 4,178,110

### Inventor: James H. Cobbs

### Issued: Dec. 11, 1979

A means of anchoring a lining of low flexural rigidity with grout into a borehole drilled in the earth, which comprises a relatively thin-walled cylinder which may be composed of steel, elastomeric or plastic material of selected diameter, which is less than that of the borehole. A plurality of keys, each having one end bonded to the wall of the cylinder, extend outwardly, and have an enlarged head portion which is adapted to be bonded to the grout, which will fill the annular space between the cylinder and the borehole. A plurality of vertically spaced support rings surround the cylinder and are attached to the cylinder by means of a plurality of keys. The support rings are supported and spaced apart by means of circumferentially spaced rods, which are attached at their ends to the support rings and are guided at intermediate positions by keys which are locked to the cylinder.

### U.S. Pat. No. 4,498,271

### Inventor: Rudolf Koniger et al.

### Issued: Feb. 12, 1985

A method and apparatus is provided for anchoring threaded bars, such as bolts or similar elements, to hardened concrete, cement, or stone. An anchoring hole and a side hole are cut in the solid structure, and a sprag is then positioned within the side hole. The sprag is in the form of a sleeve and has a screw-threaded opening which extends through it and which is adapted to receive a threaded anchoring bar. The angle between the longitudinal axis of the sprag and the opening is equal to the angle between the anchoring bar hole and the side hole which are formed in the structure. The sprag is positioned within the side hole until its threaded opening is in line with the anchoring bar hole, so that the anchoring bar can be screwed into it.

### U.S. Pat. No. 4,526,493

### Inventor: Howard H. Hall et al.

### Issued: Jul. 2, 1985

One concrete slab is laid adjacent to a previously laid slab with a slip forming machine while the concrete mix of the previously laid slab is still plastic. The slip forming machine includes a tractor of the type used with conventional slip-form mules, and in addition a slip-form mule that has the capability of laying a slab of plastic concrete mix against a previously laid slab of mix that is still plastic. The mule has a frame that is attached to the tractor, and the frame carries a hopper and slip form which are united into a single unit, with the hopper opening into the front end of the slip form. The unitized hopper and slip form pivot on the frame about a vertical axis that extends through the front of the frame. The rear end of the slip form moves on a transverse slideway and a hydraulic cylinder is connected between the frame and slip form to urge the side of the slip form snugly against the edge of the previously laid slab as concrete mix extrudes from the slip form to provide the adjacent slab. This insures that the slabs are in edge-to-edge contact. The elevation of the slip form is controlled by sensors which follow skis, and the skis in turn ride the surface of the previously laid slab. The direction of the tractor, and likewise the slip form which is on it, is controlled by a sensor which follows an edge ski that rides that edge of the previously laid slab against which the extruded slab is laid.

### U.S. Pat. No. 4,887,789

### Inventor: Frank R. Harris et al.

### Issued: Dec. 19, 1989

The present invention relates to a form for molding building components, such as columns, having a desired size, shape, and surface features from solidifying building materials such as concrete. The form is sculpted from a plastic material such as polystyrene or urethane. The cylinder is hollowed so that the interior of the resulting form has the size, shape, and surface features of the desired building component.

### U.S. Pat. No. 5,851,564

### Inventor: Jay Triandafilou

### Issued: Dec. 22, 1998

An apparatus for making a lightweight, thin wall, seamless, hollow structural profile using a simple mold. The apparatus includes a base for supporting a mandril and a two piece outer form which bolts together assembled. A mixture is poured or injected into the space between the mandril and the form to produce a profile upon hardening of the mixture of either cement, fiberglass or polymers. The hollow area of the structural profile may be filled with various materials. The base comprises a plurality of upwardly rising columns or blocks and posts around the inside perimeter of the mandril and blocks around the outside perimeter of the form for proper positioning of the mandril and the form, which are separated by a predetermined distance in accordance with the desired features and dimensions of the structural profile.

### U.S. Pat. No. 5,881,510

### Inventor: James Ole

### Issued: Mar. 16, 1999

A window frame device is disclosed for permitting the adjustable setting of a window frame adjacent to a foundation form. The device includes a window frame which has a head having a first and a second side, the first and second sides defining respectively a first and a second slot. A sill has a first and a second extremity, the first and second extremities defining respectively a first and a second channel. A first jamb extends between the first side of the head and the first extremity of the sill and a second jamb extends between the second side of the head and the second extremity of the sill. A first tie adapter has a first and a second end, the first end defining a tenon which cooperates with the first slot, the second end defining a tab which cooperates with the first channel. A second tie adapter has a first and a second edge, the first edge defining a further tenon which cooperates with the second slot. The second edge defines a further tab which cooperates with the second channel, the arrangement being such that when the tie adapters are located adjacent to the respective jambs with the tenons and tabs cooperating with the respective slots and channels, the adjustable setting of the window frame relative to the foundation form is permitted.

### U.S. Pat. No. 5,996,293

### Inventor: Justin J. Anderson

### Issued: Dec. 7, 1999

A window buck is formed of side walls that are extruded from vinyl. The side walls have interior channels. The side walls may be formed to effect a female-male connection between the ends of two adjoining side walls. Alternatively a locking member is provided that is sized to frictionally engage a selected channel. The edges of the side members are shaped for abutment to each other with a connector in the channels to hold the window buck together. The window buck thereafter may be placed before the cement wall is formed and is sized to receive a window frame. The window buck may be formed into selected geometric shapes. Window bucks of different dimensions may be assembled by selected sides of different dimensions from bins or pallets of presized side members.

### U.S. Pat. No. 6,070,375

### Inventor: Justin J. Anderson, et al.

### Issued: Jun. 6, 2000

A frame is formed of side walls that are extruded from vinyl. The side walls have interior channels. The side walls may be formed to effect a female-male connection between the ends of two adjoining side walls. Alternatively a locking member is provided that is sized to frictionally engage a selected channel. The side walls have a concrete retention fin positioned to extend away from the outer wall of the side wall to interconnect with the concrete as the and after the concrete cures. The frame may be formed into door jambs, doors, and the like. The frame may also be a window buck that may be formed into selected geometric shapes. Window bucks of different dimensions may be assembled on site by sawing.

### U.S. Pat. No. 6,185,884

### Inventor: Dallas E. Myers, et al.

### Issued: Feb. 13, 2001

A system and associated method for forming a window opening in a poured concrete wall and installing a window therein includes a two-piece reusable window buck having a retainer temporarily coupled thereto. The retainer becomes partially embedded in the poured concrete wall and after the window buck is removed from the window opening formed in the wall, the window is easily and conveniently installed in the window opening and secured therein by the window retainer and cooperating spring clip on the window frame without the need for additional mechanical fasteners or tools.

### U.S. Pat. No. 6,202,369

### Inventor: Stanley Partee, et al.

### Issued: Mar. 20, 2001

An anchor system for alternate types of signage includes an elongated anchor member and an attached, lowermost formation engageable with an underlying foundation to firmly support the anchor member in a substantially vertical disposition. A bore within the anchor member slidably receives the lower portion of an elongated sign pole or marker device, with a stop element within the anchor member serving to limit the length of the sign pole inserted therewithin. Secure attachment of the sign pole relative the vertical anchor member is achieved by the application of a compression element comprising a collar and having a tapered, inner surface engageable with the upper portion of the anchor member. The inclusion of a plurality of slots in the upper portion of the anchor member provides individual segments which are subsequently deflected radially inwardly upon the tightening of the compression element. Sign poles of lesser diameters may be accommodated with any one anchor member by the insertion of a split sleeve adaptor intermediate the sign pole and anchor member, while altering the height of the anchor member allows attachment of various types and sizes of signage, including signs atop the pole or barricade poles for traffic marking. Various materials may be used for the components, such as metal or nonmetallic, with the latter particularly adaptable for traffic barricades and wherein the anchor member is of minimal height.

### U.S. Pat. No. 6,302,785

### Inventor: Richard McKinney, et al.

### Issued: Oct. 16, 2001

An improved foundation vent with increased net free area is provided. The foundation vent has a frame that surrounds and defines an opening and a grill supported by the frame and spanning the opening. The grill has an inside face disposed on the inside of a crawlspace when the vent is mounted in a foundation wall and an outside face disposed on the outside of the crawlspace. A mesh screen is mounted to the frame and spans the opening adjacent the inside face of the grill. The grill is provided with projecting standoffs that support the screen at a predetermined distance from the inside face of the grill to form a plenum between the screen and the grill. A raised peripheral rim is provided on the frame and supports the peripheral portion of the screen. The spacing of the screen from the inside face of the grill and the plenum formed thereby unblocks the portions of the screen that otherwise would be blocked by the members of the grill and thus increases the net free area of the foundation vent.

### U.S. Pat. No. 6,453,620

### Inventor: Michael J. Williams, et al.

### Issued: Sep. 24, 2002

A window buck having members forming a frame with the members including adjustable components enabling use of the buck in walls under construction of different thicknesses. Extruded front and rear components of each buck member are adjustably interengaged with one another and fixable in a desired relationship to suit the wall being constructed. External channels formed in the buck members are open lengthwise to permit reception of angular connectors for joining the buck members at their intersecting ends. The connectors may be of reusable rebar and removable upon completion of the wall. The components of each buck member are lockable by inserted fasteners. A modified window buck includes a central component for use in walls of extraordinary thicknesses. A further modified window buck may include buck members of unitary construction.

### U.S. Pat. No. 6,550,819

### Inventor: Nicholas DeSanto Sr.

### Issued: Apr. 22, 2003

A protective sleeve in the form of a pressure relieving arch having a pair of split pipe sleeves for surrounding an uncut pipe or an uncut piping system preventing breakage by relieving structural strain from loads of a wall, footing or foundation around the pipe or piping system being protected. The pressure relieving arch includes a first protective pipe sleeve in the shape of a hollow semi-circle having a first pair of mating edges; and a second protective pipe sleeve in the shape of a hollow semi-circle having a second pair of mating edges. The first pair of mating edges of the first protective pipe sleeve for mating and connecting with the second pair of mating edges of the second protective pipe sleeve for forming a hollow and cylindrically-shaped pressure relieving arch. The pressure relieving arch is used for surrounding an uncut individual pipe or a plurality of uncut pipes within a piping system for preventing pipe breakage by relieving and preventing structural strain from loads of walls, footings, foundations or ground around the pipe or piping system.

### U.S. Patent Publication Number 2002/0062620

### Inventor: Juan Beltran

### Published: May 30, 2002

A pole anchor installation having an anchor base with a central threaded open-ended hole mounted in a receptacle formed in a planking or concrete of a deck. An elongated sleeve having external threads is threadably fitted into the threaded opening of the anchor base so that the sleeve upwardly projects to insertably receive a substantial portion of a pole intended to be supported. A threaded blockage plug is received in the threaded opening of the anchor base when the sleeve and pole are not employed preventing clogging of the threaded opening. In a wood foundation, angular threaded bores are provided into which mounting screws are placed to secure the anchor base. In a concrete block or cement slab, reinforcing rods are carried on the underside of the anchor base and are embedded within the material of the block or slab. In either type of installation, the top surface of the support anchor base is flush with the surrounding surface of either the wood planking or the cement block or cement slab.

### United Kingdom Patent Number GB 2,307,530

### Inventor: Jonathan Gibbons

### Issued May 28, 1997

A method for terminating a pipe sleeve (1) passing through a cavity wall and containing gas pipes therein comprises fitting a terminating flange member (8) to the ends of the pipe sleeve (1) and securing the terminating flange member (8) to the pipe sleeve (1) to provide a gas tight seal. The terminating flange member (8) has a planar circular face member (3) with a central cut out portion of circular section, a cylindrical portion (7) extends from the rear of the face member (3) around the circumference of the cut out portion at right angles to the face member (3). The cylindrical portion (7) fits around the end of the pipe sleeve (1) leaving a gap to allow the components to be sealed together, by solder adhesive or intumescent silicone if the flange and sleeve are copper or solvent cement or intumescent silicone if they are of ABS. The components can be provided in kit form.

While these devices may be suitable for the purposes for which they were designed, they would not be as suitable for the purposes of the present invention, as hereinafter described.

### SUMMARY OF THE PRESENT INVENTION

A primary object of the present invention is to provide a ventilation sleeve comprising a pivoting breakaway swing door encased in a housing to be installed in a building foundation.

Another object of the present is to provide a ventilation sleeve with a breakaway door that is bi-directionally pivotable.

A further object of the present invention is to provide a ventilation sleeve wherein said breakaway door is retained in place during normal conditions by a resilient gasket residing in a retaining channel within the frame.

Yet another object of the present invention is to provide a ventilation sleeve wherein the resilient gasket responds to an applied force of 10-20 PSI by flexing past the retaining channel to enable the door to swing open accordingly to relieve the pressure on the applied side.

Still yet another object of the present invention is to provide a ventilation sleeve with a pivotable breakaway door comprising a frame grid with an attached screen member and a removable magnetic winter plate that requires no hardware or tools for installation and removal.

Additional objects of the present invention will appear as the description proceeds.

The present invention overcomes the shortcomings of the prior art by providing a vent for a building structure, specifically for the foundation thereof, having a bi-directional breakaway swing door that releases in either direction once a predetermined PSI of pressure is applied thereto. This is done to meet building codes in flood prone areas and to protect the structure in the event of flooding as the breakaway door opens accordingly once 10-20 PSI is exerted thereupon.

The foregoing and other objects and advantages will appear from the description to follow. In the description reference is made to the accompanying drawings, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWING FIGURES

In order that the invention may be more fully understood, it will now be described, by way of example, with reference to the accompanying drawing in which:

FIG. 1 is an illustrative view of the present invention in use;

FIG. 2 is a perspective view of the present invention;

FIG. 3 is a front view of the present invention;

FIG. 4 is a rear view of the present invention;

FIG. 5 is a sectional side view of the present invention;

FIG. 6 is a sectional side view of the present invention;

FIG. 7 is a sectional side view of the present invention;

FIG. 8 is a front view of the present invention with winter plate; and

FIG. 9 is a side sectional detail view of the present invention.

### DESCRIPTION OF THE REFERENCED NUMERALS

Turning now descriptively to the drawings, in which similar reference characters denote similar elements throughout the several views, the Figures illustrate the Ventilation Sleeve with Bi-Directional Breakaway Door of the present invention. With regard to the reference numerals used, the following numbering is used throughout the various drawing figures.
10 Ventilation Sleeve with Bi-Directional Breakaway Door
12 housing
14 bi-directional breakaway swing door
16 frame of 14
18 screen member
19 securement points of 18
20 resilient gasket
22 gasket retaining channel
24 pivoting connector
26 pivot hook of 14
28 pivot post of 12
30 magnetic winter plate
32 building structure
34 foundation wall of 32
36 galvanized powder coating

### DETAILED DESCRIPTION OF THE PREFERRED EMBODIMENT

The following discussion describes in detail one embodiment of the invention (and several variations of that embodiment). This discussion should not be construed, however, as limiting the invention to those particular embodiments, practitioners skilled in the art will recognize numerous other embodiments as well. For definition of the complete scope of the invention, the reader is directed to appended claims.

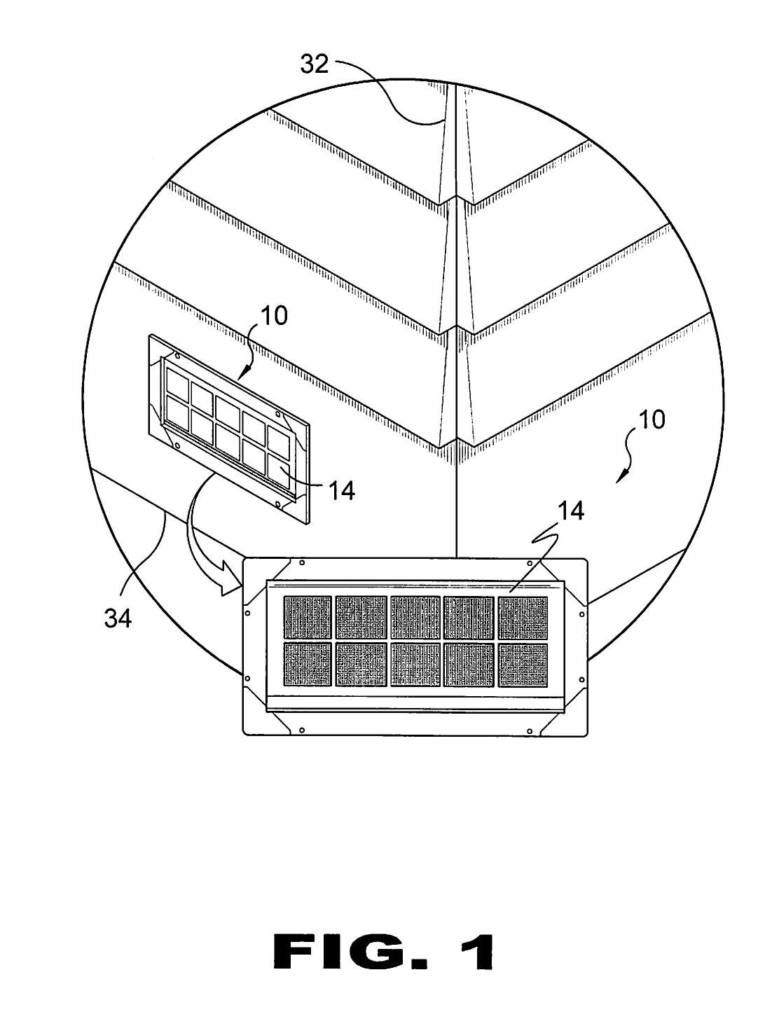

FIG. 1 is an illustrative view of the present invention 10 in use. The present invention 10 is an air vent for a building structure 32, specifically for the foundation wall 34 thereof, having a pressure actuated bi-directional breakaway swing door 14 that releases in either direction once a predetermined PSI of pressure is applied thereto. This is done to meet building codes in flood prone areas and to protect the structure 32 in the event of flooding as the breakaway door 14 opens accordingly once 10-20 PSI is exerted thereupon.

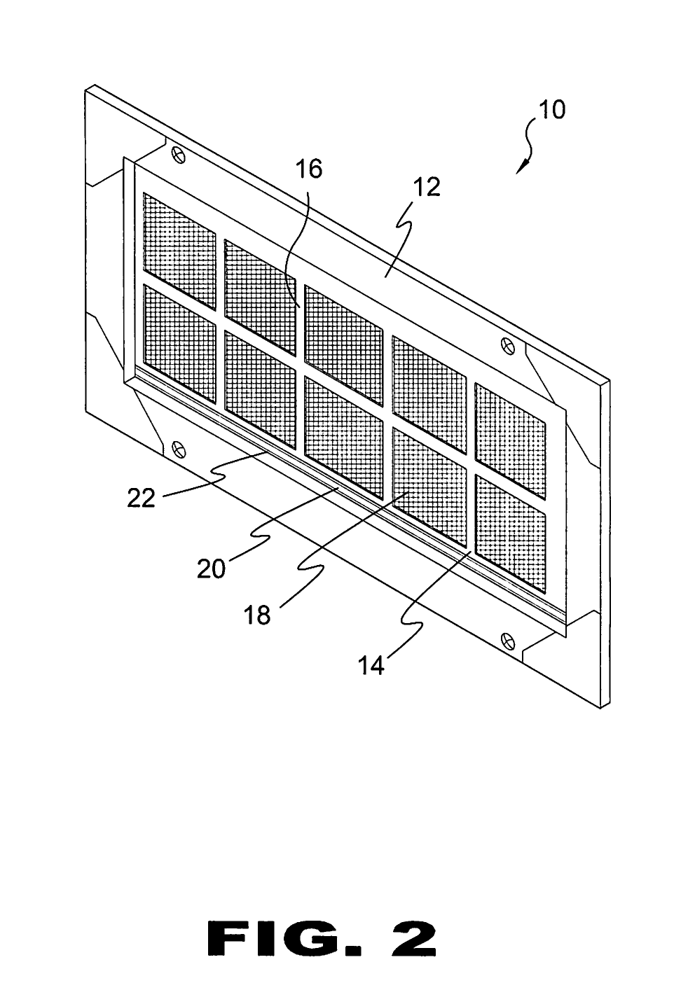

FIG. 2 is a perspective view of the present invention 10. Shown is a perspective view of the present invention 10, a hinged bi-directional breakaway door 14 mounted in an exclusive adjustable galvanized housing sleeve 12. A breakaway hinged door has a resilient EPDM type rubber seal 20 to release the door from a retainer channel 22 in lower housing sleeve 12. The door 14 comprises a frame grid 16 with a screen 18 fastened thereto at various securement points and the top is pivotally connected to the housing and the bottom is releasably retained therein by the resilient gasket 20 within the channel 22. The device is mounted in building foundations to meet air and flood building codes.

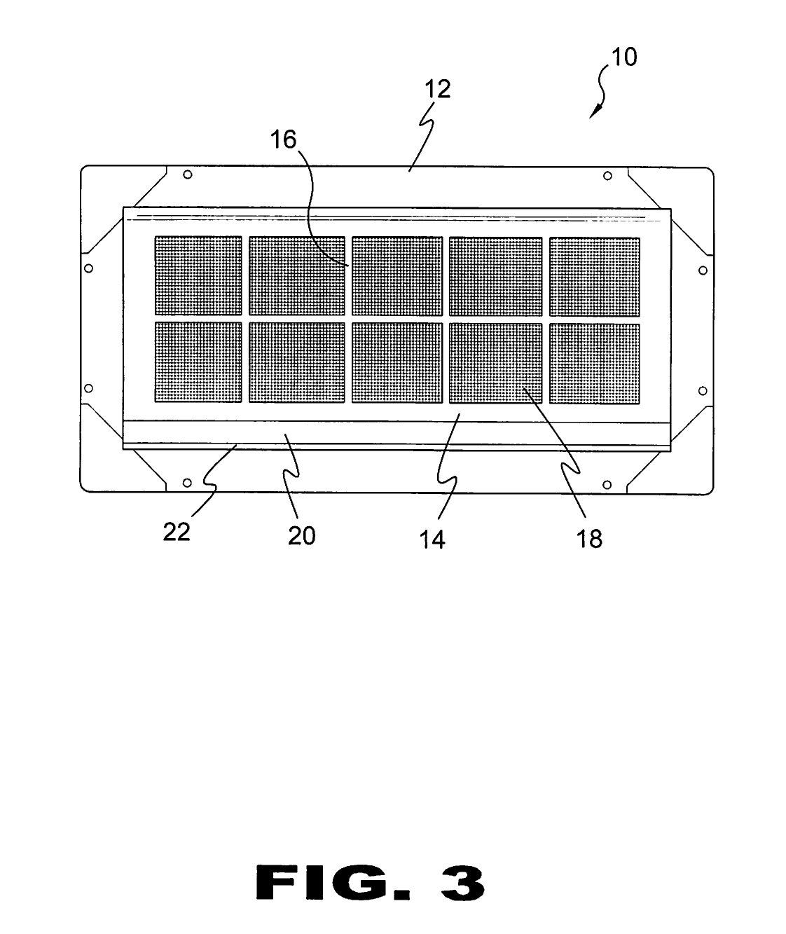

FIG. 3 is a front view of the present invention 10. Shown is a front view of the present invention 10, a hinged bi-directional breakaway door 14 mounted in an exclusive adjustable galvanized housing sleeve 12. A breakaway hinged door 14 has a resilient EPDM type rubber seal 20 to release the door from a retainer channel 22 in lower housing sleeve 12. The door 14 comprises a frame grid 16 with a screen 18 fastened thereto at various securement points and the top is pivotally connected to the housing and the bottom is releasably retained therein by the resilient gasket 20 within the channel 22. The device is mounted in building foundations to meet air and flood building codes.

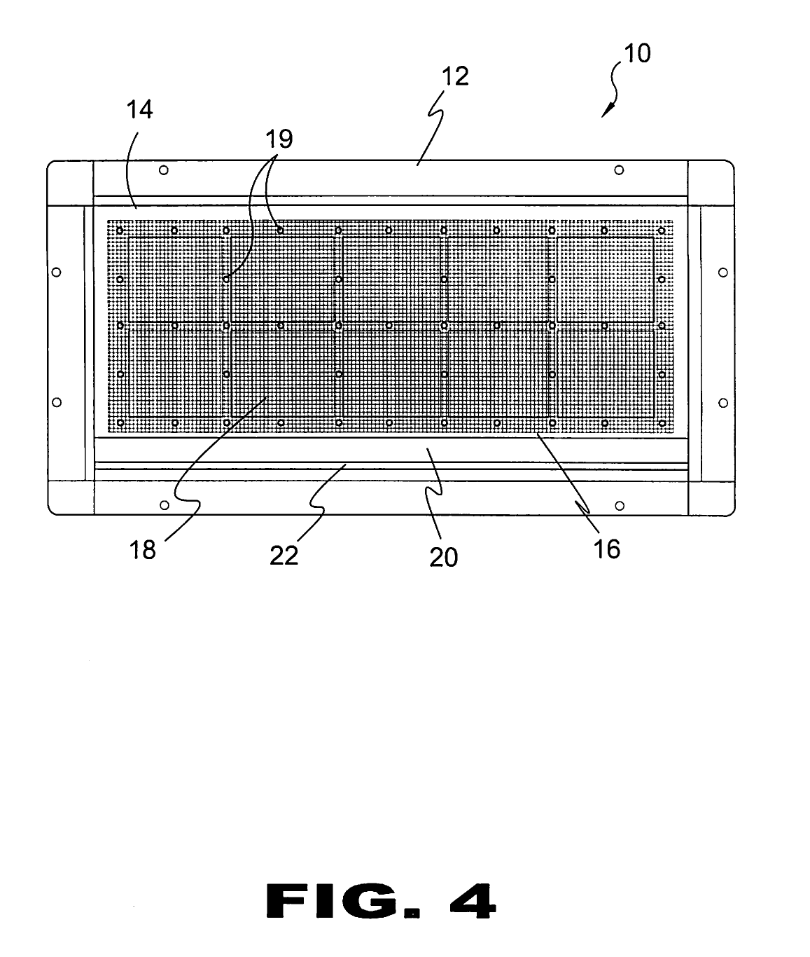

FIG. 4 is a rear view of the present invention 10. Shown is a front view of the present invention 10, a hinged bi-directional breakaway door 14 mounted in an exclusive adjustable galvanized housing sleeve 12. A breakaway hinged door 14 has a resilient EPDM type rubber seal 20 to release the door from a retainer channel 22 in lower housing sleeve 12. The door 14 comprises a frame grid 16 with a screen 18 fastened thereto at various securement points 19 and the top is pivotally connected to the housing and the bottom is releasably retained therein by the resilient gasket 20 within the channel 22. The device is mounted in building foundations to meet air and flood building codes.

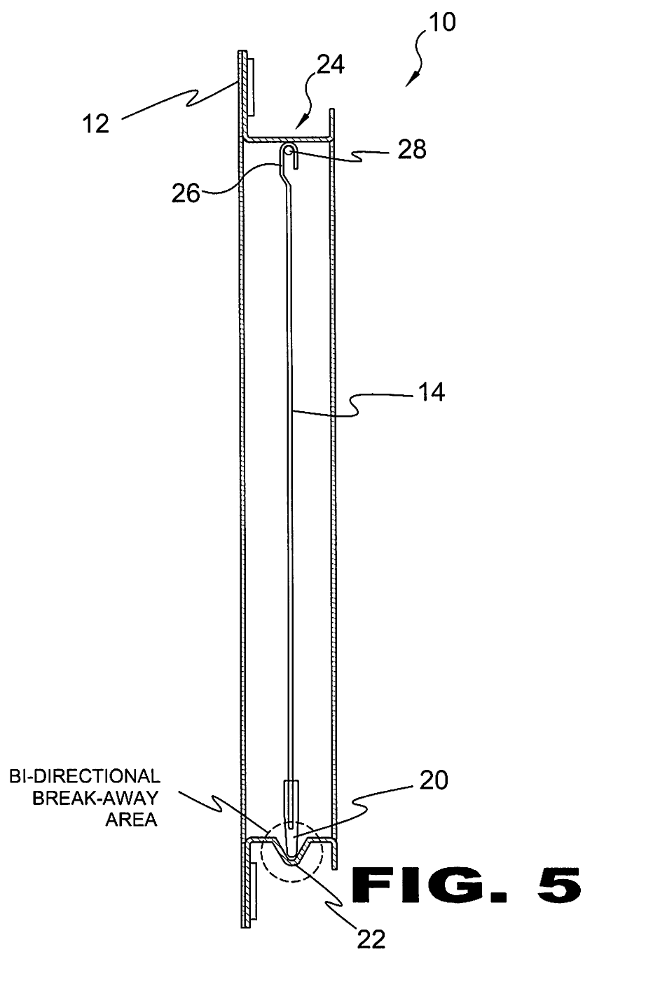

FIG. 5 is a sectional side view of the present invention 10. The present invention 10 is a hinged bi-directional breakaway door 14 mounted in an exclusive adjustable galvanized housing sleeve 12. The breakaway hinged door has a resilient EPDM type rubber seal 20 to release door from a retainer channel 22 in lower housing sleeve 12. The door 14 includes a pivoting connector 24 comprising a pivot hook 26 on top of the door 14 that swings on a pivot post 28 within the sleeve 12.

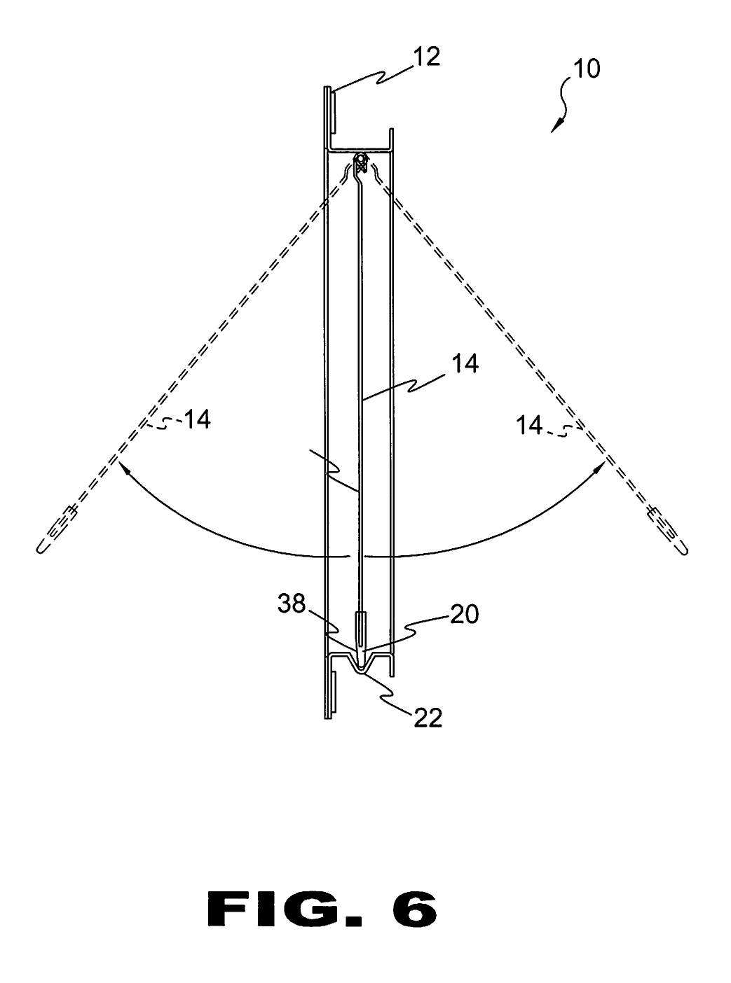

FIG. 6 is a sectional side view of the present invention 10. Shown is the pivoting action of the bi-directional door 14 when the gasket 20 has a strong enough bias to deform the gasket 20 to urge it from the retaining channel 22. The door 14 has a galvanized coating. The gasket 20 is manufactured of an EPMD type rubber 38.

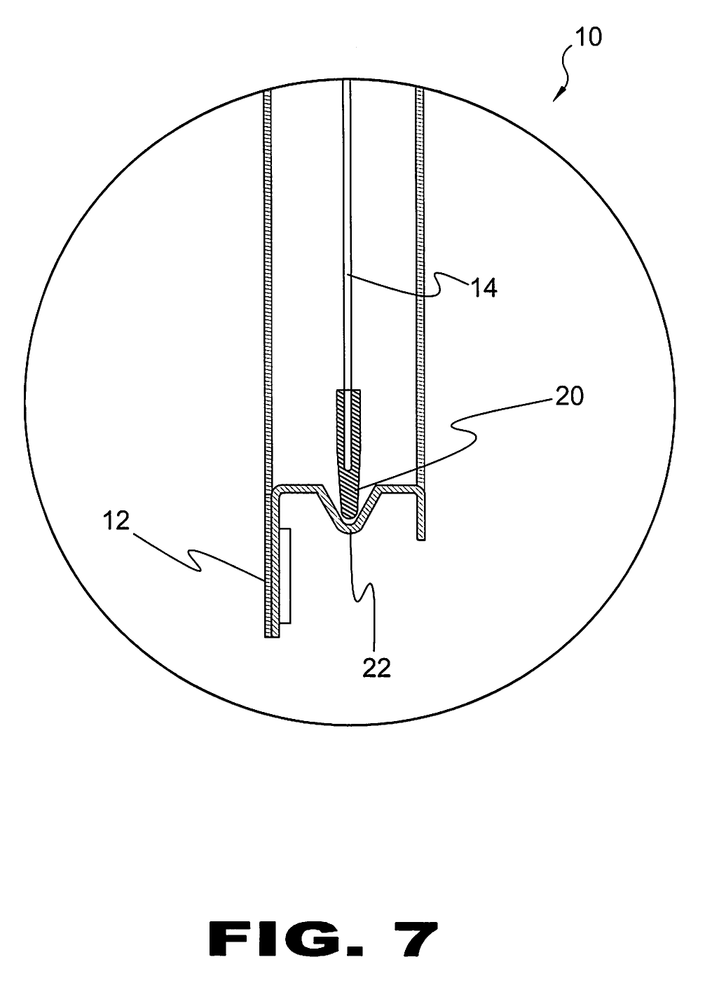

FIG. 7 is a detailed sectional side view of the present invention 10 showing the bi-directional door 14 in its normal installed position with the gasket 20 nestled deep into the V-shaped retaining channel 22 of the housing 12.

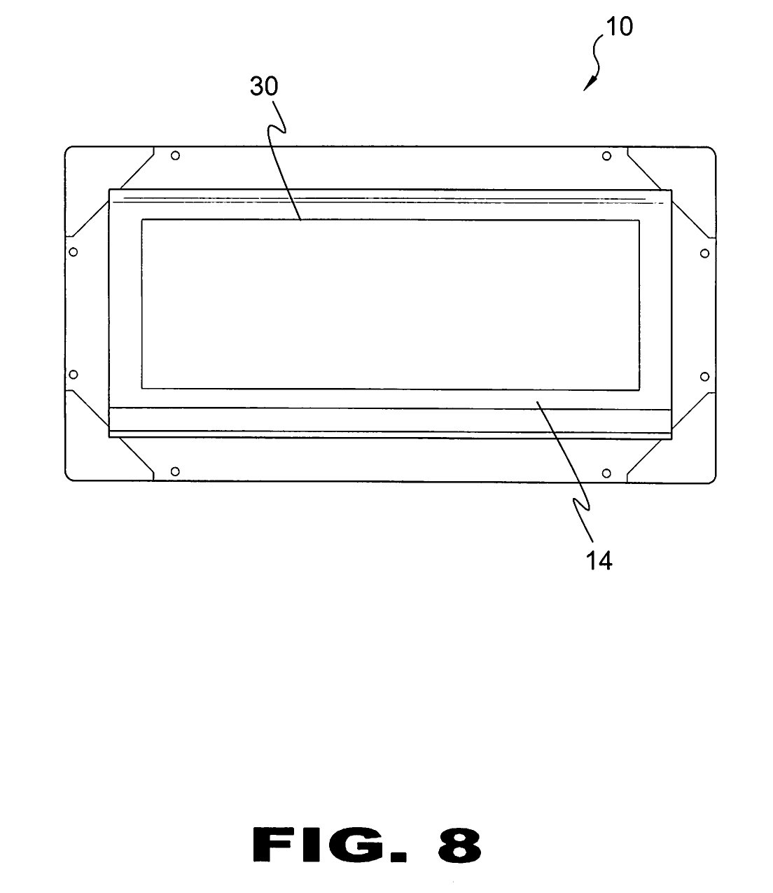

FIG. 8 is a front view of the present invention 10 with the winter plate 30. The winter plate 30 mounts directly to the metallic door 12 thereby eliminating the need for tools or hardware for installation and removal.

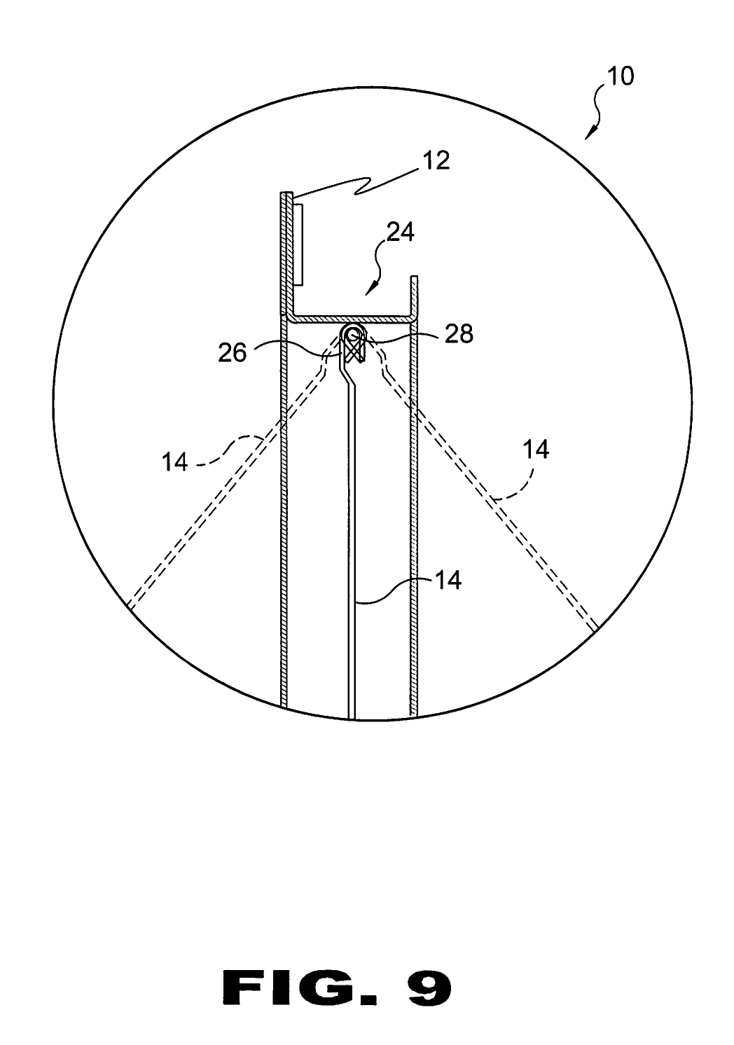

FIG. 9 is a side sectional detail view of the pivot connection 24 of the present invention 10. The pivoting connector 24 comprising a pivot hook 26 on top of the door 14 that swings on a pivot post 28 within the sleeve 12.

What is claimed is new and desired to be protected by Letters Patent is set forth in the appended claims:

1. A ventilation sleeve having a pressure-actuated breakaway swing door comprising:
a) a housing sleeve for installation within the foundation wall of a building structure;
b) a vented bi-directional swinging door pivotally secured to the interior top portion of said housing sleeve; and
c) means for maintaining said bi-directional door in a secure position until pressure within a predetermined range is applied to one side thereof which results in the door opening to allow passage of the source of the applied force.

2. The ventilation sleeve having a pressure-actuated breakaway swing door recited in claim 1, wherein said door includes a metallic grid frame.

3. The ventilation sleeve having a pressure-actuated breakaway swing door recited in claim 2, wherein said door further includes a screen.

4. The ventilation sleeve having a pressure-actuated breakaway swing door recited in claim 3, wherein said screen is affixed to said grid frame at a plurality of securement points.

5. The ventilation sleeve having a pressure-actuated breakaway swing door recited in claim 2, wherein the top of said door is secured to the interior of said sleeve housing with a pivot connector.

6. The ventilation sleeve having a pressure-actuated breakaway swing door recited in claim 5, wherein said pivot connector comprises:
a) a pivot hook disposed on the top of said door; and
b) a mating pivot post disposed in said housing.

7. The ventilation sleeve having a pressure-actuated breakaway swing door recited in claim 6, wherein said door is designed to pivot substantially ninety degrees in each direction when necessary.

8. The ventilation sleeve having a pressure-actuated breakaway swing door recited in claim 7, wherein said door further comprises a deformable member extending downward along the length of the bottom edge of said door.

9. The ventilation sleeve having a pressure-actuated breakaway swing door recited in claim 8, wherein said deformable member is a resilient sealing gasket.

10. The ventilation sleeve having a pressure-actuated breakaway swing door recited in claim 9, wherein said gasket is fabricated of EPDM type rubber.

11. The ventilation sleeve having a pressure-actuated breakaway swing door recited in claim 9, wherein said housing further includes a gasket retaining channel interiorly disposed in the interior bottom portion thereof directly below said gasket.

12. The ventilation sleeve having a pressure-actuated breakaway swing door recited in claim 11, wherein said retaining channel the deepest in the center beneath said gasket and the two sides flaring outward to the surface.

13. The ventilation sleeve having a pressure-actuated breakaway swing door recited in claim 12, wherein the bottom edge of said door frame terminates prior to reaching the interior bottom surface of said housing.

14. The ventilation sleeve having a pressure-actuated breakaway swing door recited in claim 13, wherein said gasket extends substantially to the deep center portion of said retaining channel when in the installed static position during normal environmental conditions.

15. The ventilation sleeve having a pressure-actuated breakaway swing door recited in claim 14, wherein said gasket is rated to deform enough to exit said retaining channel when exposed to a bias on one side thereof that exceeds a preselected pressure range.

16. The ventilation sleeve having a pressure-actuated breakaway swing door recited in claim 15, wherein said gasket deforms when the applied bias exerted upon said door is substantially within the range of 10-20 PSI to conform with building codes.

17. The ventilation sleeve having a pressure-actuated breakaway swing door recited in claim 2, further includes a winter cover that is installed on said door in cooler months to restrict air flow therethrough.

18. The ventilation sleeve having a pressure-actuated breakaway swing door recited in claim 17, wherein said winter cover is magnetic.

19. The ventilation sleeve having a pressure-actuated breakaway swing door recited in claim 18, wherein said winter cover is placed directly on said frame grid for installation and simply pulled off for removal thereby eliminating the need for tools or hardware.

20. The ventilation sleeve having a pressure-actuated breakaway swing door recited in claim 2, wherein said housing sleeve and said door frame grid are coated with a galvanized powder.
